(19) United States
(12) Patent Application Publication
(10) Pub. No.: US 2017/0287505 A1
(43) Pub. Date: Oct. 5, 2017

(54) METHOD AND APPARATUS FOR LEARNING AND RECOGNIZING AUDIO SIGNAL

(71) Applicant: SAMSUNG ELECTRONICS CO., LTD., Suwon-si (JP)

(72) Inventors: Jae-hoon JEONG, Suwon-si (KR); Seung-yeol LEE, Seoul (KR); In-woo HWANG, Suwon-si (KR); Byeong-seob KO, Suwon-si (KR)

(73) Assignee: SAMSUNG ELECTRONICS CO., LTD., Suwon-si (KR)

(21) Appl. No.: 15/507,433

(22) PCT Filed: Sep. 3, 2015
(86) PCT No.: PCT/KR2015/009300

§ 371 Date: Feb. 28, 2017

Related U.S. Application Data
(60) Provisional application No. 62/045,099, filed on Sep. 3, 2014.

(51) Int. Cl. G10L 25/51; G10L 21/0232; G06N 99/00; G10L 15/10

(52) U.S. Cl. CPC G10L 25/51; G10L 15/10; G10L 21/0232; G06N 99/005

(57) ABSTRACT

Provided is a method for learning an audio signal. The method includes: acquiring at least one frequency-domain audio signal including frames; dividing the frequency-domain audio signal into at least one block by using a similarity between frames; acquiring a template vector corresponding to each block; acquiring a sequence of the acquired template vectors corresponding to at least one frame included in each block; and generating learning data including the acquired template vectors and the sequence of the template vectors.

### TECHNICAL FIELD

The inventive concept relates to methods and apparatuses for acquiring information for recognition of an audio signal by learning the audio signal, and recognizing the audio signal by using the information for recognition of the audio signal.

### BACKGROUND ART

Sound recognition technology relates to a method for pre-learning a sound to generate learning data and recognizing the sound based on the learning data. For example, when a doorbell sound is learned by a terminal apparatus of a user and then a sound identical to the learned doorbell sound is input to the terminal apparatus, the terminal apparatus may perform an operation indicating that the doorbell sound is recognized.

In order for the terminal apparatus to recognize a particular sound, it is necessary to perform a learning process for learning data generation. However, when the learning process is complex and time-consuming, the user may be inconvenienced and thus the learning process may not be performed properly. Therefore, the possibility of occurrence of an error in the learning process may be high and thus the performance of a sound recognition function may degrade.

### DISCLOSURE

### Technical Solution

The inventive concept provides methods and apparatuses for generating learning data for recognition of an audio signal more simply and recognizing the audio signal by using the learning data.

### Advantageous Effects

According to an exemplary embodiment, since the number of times of inputting the audio signal including the same sound may be minimized, the sound learning process may be performed more simply.

### DESCRIPTION OF DRAWINGS

FIG. 1 is a block diagram illustrating an internal structure of a terminal apparatus for learning an audio signal according to an exemplary embodiment.

FIG. 2 is a flowchart illustrating a method for learning an audio signal according to an exemplary embodiment.

FIG. 3 is a diagram illustrating an example of an audio signal and a similarity between audio signals according to an exemplary embodiment.

FIG. 4 is a diagram illustrating a frequency-domain audio signal according to an exemplary embodiment.

FIG. 5 is a diagram illustrating an example of acquiring a similarity between frequency-domain audio signals belonging to an adjacent frame according to an exemplary embodiment.

FIG. 6 is a block diagram illustrating an internal structure of a terminal apparatus for recognizing an audio signal according to an exemplary embodiment.

FIG. 7 is a flowchart illustrating a method for recognizing an audio signal according to an exemplary embodiment.

FIG. 8 is a block diagram illustrating an example of acquiring a template vector and a sequence of template vectors according to an exemplary embodiment.

FIG. 9 is a diagram illustrating an example of acquiring a template vector according to an exemplary embodiment.

FIG. 10 is a block diagram illustrating an internal structure of a terminal apparatus for learning an audio signal according to an exemplary embodiment.

FIG. 11 is a block diagram illustrating an internal structure of a terminal apparatus for recognizing an audio signal according to an exemplary embodiment.

### BEST MODE

According to an exemplary embodiment, a method for learning an audio signal includes: acquiring at least one frequency-domain audio signal including frames; dividing the frequency-domain audio signal into at least one block by using a similarity between frames; acquiring a template vector corresponding to each block; acquiring a sequence of the acquired template vectors corresponding to at least one frame included in each block; and generating learning data including the acquired template vectors and the sequence of the template vectors.

The dividing of the frequency-domain audio signal into at least one block may include dividing at least one frame with the similarity greater than or equal to a reference value into at least one block.

The acquiring of the template vector may include: acquiring at least one frame included in the block; and acquiring the template vector by obtaining a representative value of the acquired frame.

The sequence of the template vectors may be represented by allocating identification information of the template vector for at least one frame included in each block.

The dividing of the frequency-domain audio signal into at least one block may include: dividing a frequency band into sections; obtaining a similarity between frames in each section; determining a noise-containing section among the sections based on the similarity in each section; and obtaining the similarity between the frequency-domain audio signals belonging to the adjacent frame based on the similarity in the other section other than the determined section.

According to an exemplary embodiment, a method for recognizing an audio signal includes: acquiring at least one frequency-domain audio signal including frames; acquiring learning data including template vectors and a sequence of the template vectors; determining a template vector corresponding to each frame based on a similarity between the template vector and the frequency-domain audio signal; and recognizing the audio signal based on a similarity between a sequence of the learning data and a sequence of the determined template vectors.

The determining of the template vector corresponding to each frame may include: obtaining a similarity between the template vector and the frequency-domain audio signal of each frame; and determining the template vector as the template vector corresponding to each frame when the similarity is greater than or equal to a reference value.

According to an exemplary embodiment, a terminal apparatus for learning an audio signal includes: a reception unit configured to receive at least one frequency-domain audio signal including frames; a control unit configured to divide the frequency-domain audio signal into at least one block by using a similarity between frames, acquire a template vector corresponding to each block, acquire a sequence of the acquired template vectors corresponding to at least one frame included in each block, and generate learning data including the acquired template vectors and the sequence of the template vectors; and a storage unit configured to store the learning data.

According to an exemplary embodiment, a terminal apparatus for recognizing an audio signal includes: a reception unit configured to receive at least one frequency-domain audio signal including frames; a control unit configured to acquire learning data including template vectors and a sequence of the template vectors, determine a template vector corresponding to each frame based on a similarity between the template vector and the frequency-domain audio signal, and recognize the audio signal based on a similarity between a sequence of the learning data and a sequence of the determined template vectors; and an output unit configured to output a recognition result of the audio signal.

### MODE FOR INVENTION

Hereinafter, exemplary embodiments of the inventive concept will be described in detail with reference to the accompanying drawings. However, in the following description, well-known functions or configurations are not described in detail since they would obscure the subject matters of the inventive concept in unnecessary detail. Also, like reference numerals may denote like elements throughout the specification and drawings.

The terms or words used in the following description and claims are not limited to the general or bibliographical meanings, but are merely used by the inventor to enable a clear and consistent understanding of the inventive concept. Thus, since the embodiments described herein and the configurations illustrated in the drawings are merely exemplary embodiments of the inventive concept and do not represent all of the inventive concept, it will be understood that there may be various equivalents and modifications thereof.

In the accompanying drawings, some components may be exaggerated, omitted, or schematically illustrated, and the size of each component may not completely reflect an actual size thereof. The scope of the inventive concept is not limited by the relative sizes or distances illustrated in the accompanying drawings.

Throughout the specification, when something is referred to as “including” a component, another component may be further included unless specified otherwise. Also, when an element is referred to as being “connected” to another element, it may be “directly connected” to the other element or may be “electrically connected” to the other element with one or more intervening elements therebetween.

As used herein, the singular forms “a”, “an”, and “the” are intended to include the plural forms as well, unless the context clearly indicates otherwise. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

Also, the term “unit” used herein may refer to a software component or a hardware component such as a field-programmable gate array (FPGA) or an application-specific integrated circuit (ASIC), and the “unit” may perform certain functions. However, the term “unit” is not limited to software or hardware. The “unit” may be configured so as to be in an addressable storage medium, or may be configured so as to operate one or more processors. Thus, for example, the “unit” may include components, such as software components, object-oriented software components, class components, and task components, processes, functions, attributes, procedures, subroutines, segments of program codes, drivers, firmware, microcodes, circuits, data, databases, data structures, tables, arrays, and variables. A function provided by the components and “units” may be associated with the smaller number of components and “units”, or may be divided into additional components and “units”.

Hereinafter, exemplary embodiments of the inventive concept will be described in detail with reference to the accompanying drawings so that those of ordinary skill in the art may easily implement the exemplary embodiments. However, the exemplary embodiments may have different forms and should not be construed as being limited to the descriptions set forth herein. In addition, portions irrelevant to the description of the exemplary embodiments will be omitted in the drawings for a clear description of the exemplary embodiments, and like reference numerals will denote like elements throughout the specification.

Hereinafter, exemplary embodiments of the inventive concept will be described with reference to the accompanying drawings.

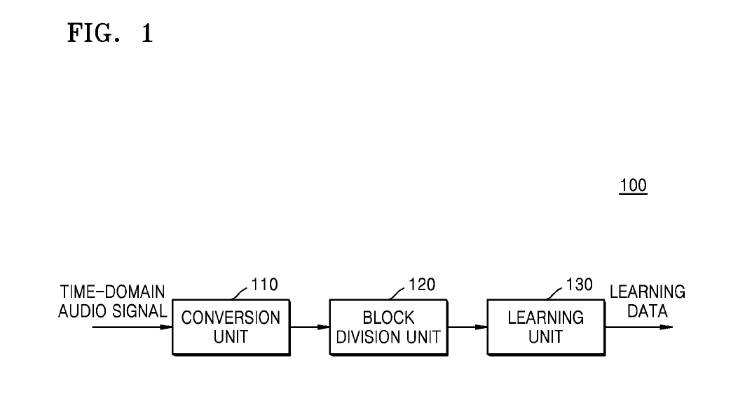

An apparatus and method for learning an audio signal will be described in detail with reference to FIGS. 1 to 5.

FIG. 1 is a block diagram illustrating an internal structure of a terminal apparatus for learning an audio signal according to an exemplary embodiment.

A terminal apparatus 100 for learning an audio signal may generate learning data by learning an input audio signal. The audio signal learnable by the terminal apparatus 100 may be a signal including a sound that is to be registered by a user. The learning data generated by the terminal apparatus may be used to recognize a pre-registered sound. For example, the terminal apparatus may use the learning data to determine whether an audio signal input through a microphone includes the pre-registered sound.

In order to perform a learning process for sound recognition, the terminal apparatus may generate learning data by extracting a statistical feature from an audio signal including a sound that is to be registered. In order to collect sufficient data for learning data generation, an audio signal including the same sound may need to be input several times to the terminal apparatus. For example, according to which statistical feature needs to be extracted from the audio signal, the audio signal may need to be input several times to the terminal apparatus. However, as the number of times for the audio signal to be input to the terminal apparatus increases, the user may be troubled and inconvenienced in the sound learning process and thus the sound recognition performance of the terminal apparatus may degrade.

According to an exemplary embodiment, the learning data about a pre-registered audio signal may include at least one template vector and a sequence of template vectors. The template vector may be determined for each block determined according to the similarity between audio signals of an adjacent frame. Thus, even when the audio signal includes a noise or a sound variation occurs slightly, since the template vector is determined for each block, the template vectors acquirable from the audio signal and the sequence thereof may change little. Since the learning data may be generated even when the audio signal is not input several times in the learning process, the terminal apparatus may perform the audio signal learning process more simply. For example, even by only once receiving the input audio signal including a sound to be registered, the terminal apparatus may generate the learning data without the need to additionally receive the input audio signal including the same sound in consideration of the audio signal variation possibility.

Referring to FIG. 1, the terminal apparatus 100 for learning an audio signal may include a conversion unit 110, a block division unit 120, and a learning unit 130.

The terminal apparatus 100 for learning an audio signal according to an exemplary embodiment may be any terminal apparatus that may be used by the user. For example, the terminal apparatus 100 may include smart televisions (TVs), ultra high definition (UHD) TVs, monitors, personal computers (PCs), notebook computers, mobile phones, tablet PCs, navigation terminals, smart phones, personal digital assistants (PDAs), portable multimedia players (PMPs), and digital broadcast receivers. The terminal apparatus 100 is not limited to the above example and may include various types of apparatuses.

The conversion unit 110 may convert a time-domain audio signal input to the terminal apparatus 100 into a frequency-domain audio signal. The conversion unit 110 may frequency-convert an audio signal in units of frames. The conversion unit 110 may generate a frequency-domain audio signal corresponding to each frame. The conversion unit 110 is not limited thereto and may frequency-convert a time-domain audio signal in various time units. In the following description, it is assumed that the audio signal is processed in units of frames. Also, the frequency-domain audio signal may be referred to as a frequency spectrum or a vector.

The block division unit 120 may divide a frequency-domain audio signal including frames into at least one block. The user may distinguish between different sounds based on the frequencies of sounds. Thus, the block division unit 120 may divide a block by using a frequency-domain audio signal. The block division unit 120 may divide a block for obtaining a template vector according to the similarity (or correlation) between adjacent frames. The block division unit 120 may divide a block according to whether it may be recognized as one sound by the user, and may obtain a template vector representing an audio signal included in each block.

The block division unit 120 may calculate the similarity of frequency-domain audio signals belonging to an adjacent frame and determine a frame section with a similarity value greater than or equal to a predetermined reference value. Then, the block division unit 120 may divide a time-domain audio signal into one or more blocks according to whether the similarity is constantly maintained in the frame section with the similarity value greater than or equal to the predetermined reference value. For example, the block division unit 120 may determine a section, in which the similarity value greater than or equal to the reference value is constantly maintained, as one block.

The learning unit 130 may generate learning data from the audio signal divided into one or more blocks by the block division unit 120. The learning unit 130 may obtain a template vector for each block and acquire a sequence of template vectors.

The template vector may be determined from the frequency-domain audio signal included in the block. For example, the template vector may be determined as a representative value, such as a mean value, a median value, or a modal value, about the audio signal included in the block. The template vector may include a representative value of the audio signal determined for each frequency band. The template vector may be a value such as a frequency spectrum having an amplitude value for each frequency band.

The learning unit 130 may allocate identification information for at least one template vector determined by the block division unit 120. The learning unit 130 may grant identification information to each template vector according to whether the template vector values are identical to each other or the similarity between template vectors is greater than or equal to a certain reference value. The same identification information may be allocated to the template vectors that are determined as being identical to each other.

The learning unit 130 may obtain a sequence of template vectors by using the identification information allocated for each template vector. The sequence of template vectors may be acquired in units of frames or in various time units. For example, the sequence of template vectors may include identification information of the template vector for each frame of the audio signal.

The template vectors and the sequence of template vectors acquired by the learning unit 130 may be output as the learning data of the audio signal. For example, the learning data may include information about the sequence of template vectors and as many template vectors as the number of blocks. The learning data may be stored in a storage space of the terminal apparatus 100 and may be thereafter used to recognize an audio signal.

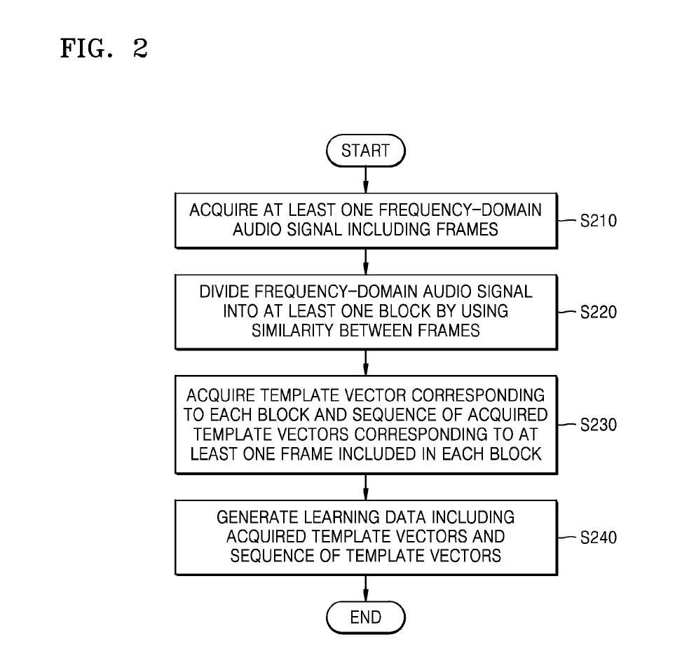

FIG. 2 is a flowchart illustrating a method for learning an audio signal according to an exemplary embodiment. The method illustrated in FIG. 2 may be performed by the terminal apparatus 100 illustrated in FIG. 1.

Referring to FIG. 2, in operation S210, the terminal apparatus 100 may acquire at least one frequency-domain audio signal including frames by converting an audio signal into a frequency-domain signal. The terminal apparatus 100 may generate learning data about the audio signal from the frequency-domain audio signal. The audio signal of operation S210 may include a sound that is to be pre-registered by the user.

In operation S220, the terminal apparatus 100 may divide the frequency-domain audio signal into at least one block based on the similarity of the audio signal between frames. The similarity determined for each frame may be determined from the similarity between the frequency-domain audio signals belonging to each frame and an adjacent frame. For example, the similarity may be determined from the similarity between the audio signal of each frame and the audio signal of the next or previous frame. The terminal apparatus 100 may divide the audio signal into one or more blocks according to whether the similarity value is constantly maintained in a section where the similarity in each frame is greater than or equal to a certain reference value. For example, in the section with the similarity greater than or equal to a certain reference value, the terminal apparatus 100 may divide the audio signal into blocks according to the change degree of the similarity value.

The similarity between the frequency-domain audio signals may be obtained by measuring the similarity between two signals. For example, a similarity “r” may be acquired according to Equation 1 below. In Equation 1, “A” and “B” are respectively vector values representing frequency-domain audio signals. The similarity may have a value of 0 to 1. The similarity may have a value closer to 1 as the two signals become more similar to each other.

$$r = \frac{A \cdot B}{\vert A \vert \cdot \vert B \vert} \qquad [ Equation 1 ]$$

In operation S230, the terminal apparatus 100 may acquire a template vector and a sequence of template vectors based on the frequency-domain audio signal included in the block. The terminal apparatus 100 may obtain a template vector from one or more frequency-domain audio signals included in the block. For example, the template vector may be determined as a representative value of vectors included in the block. The above vector represents a frequency-domain audio signal.

Also, the terminal apparatus 100 may grant different identification information for discrimination between template vectors according to the identity or similarity degree between the template vectors. The terminal apparatus 100 may determine a sequence of template vectors by using the identification information granted for each template vector. The sequence of template vectors may be determined sequentially according to the time sequence of the template vector determined for each block. The sequence of template vectors may be determined in units of frames.

In operation S240, the terminal apparatus 100 may generate learning data including the template vectors and the sequence of template vectors acquired in operation S230. The learning data may be used as data for recognizing an audio signal.

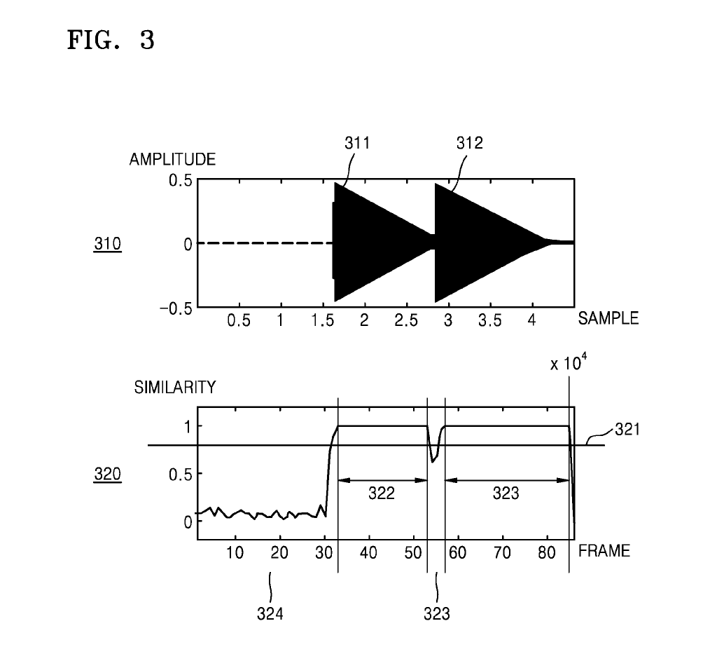

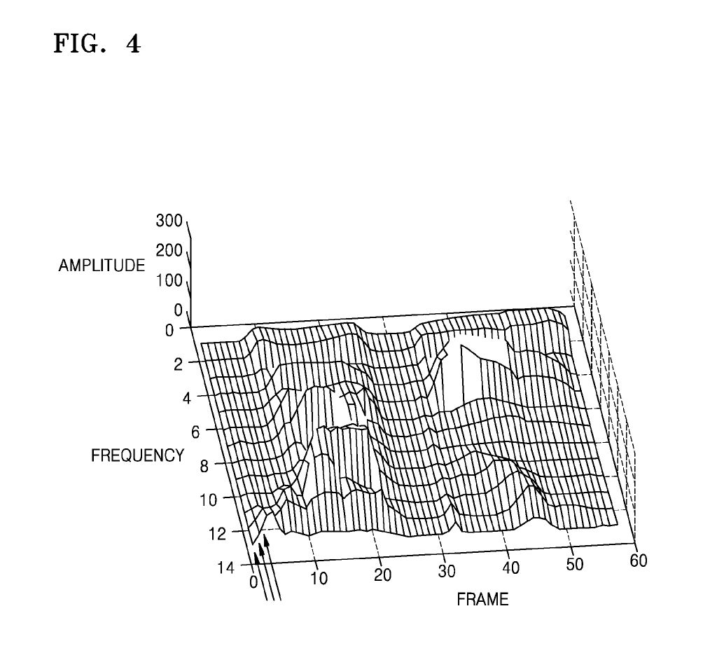

Hereinafter, the method for learning an audio signal will be described in more detail with reference to FIGS. 3 and 4.

FIG. 3 is a diagram illustrating an example of the audio signal and the similarity between audio signals according to an exemplary embodiment.

“310” is a graph illustrating an example of a time-domain audio signal that may be input to the terminal apparatus 100. When the input audio signal includes two different sounds such as doorbell sounds of, for example, “ding-dong”, it may be represented as the graph 310. A “ding” sound may appear from a “ding” start time 311 to a “dong” start time 312, and a “dong” sound may appear from the “dong” start time 312. Due to their different frequency spectrums, the “ding” sound and the “dong” sound may be recognized as different sounds by the user. The terminal apparatus 100 may divide the audio signal illustrated in the graph 310 into frames and acquire a frequency-domain audio signal for each frame.

“320” is a graph illustrating the similarity between the frequency-domain audio signals frequency-converted from the audio signal of the graph 310 belonging to an adjacent frame. Since an irregular noise is included in a section 324 before the appearance of the “ding” sound, the similarity in the section 324 may have a value close to 0.

In a section 322 where the “ding” sound appears, since the same-level sound continues, the similarity between frequency spectrums may appear high. The section 322 where the similarity value is constantly maintained may be allocated as one block.

In a section 323 where the similarity value changes temporarily, since the appearing “dong” sound overlaps with the previously-appearing “ding” sound, the similarity value may decrease. The similarity value may increase again as the “ding” sound disappears. In a section 323 where the “dong” sound appears, since the same-level sound continues, the similarity between frequency spectrums may appear high. The section 323 where the similarity value is constantly maintained may be allocated as one block.

With respect to the sections 322 and 323 allocated as blocks, based on the audio signal belonging to each block, the terminal apparatus 100 may obtain a template vector corresponding to each block and acquire a sequence of template vectors to generate learning data.

The sequence of template vectors may be determined in units of frames. For example, it is assumed that the audio signal includes two template vectors, the template vector corresponding to the section 322 is referred to as T1, and the template vector corresponding to the section 323 is referred to as T2. When the lengths of the sections 322 and 323 are respectively 5 frames and 7 frames and the length of the section 323 with the low similarity value is 2 frames, the sequence of template vectors may be determined as “T1, T1, T1, T1, T1, −1, −1, T2, T2, T2, T2, T2, T2, T2” in units of frames. “−1” represents a section that is not included in the block because the similarity value is lower than a reference value. The section that is not included in the block may be represented as “−1” in the sequence of template vectors because there is no template vector.

FIG. 4 is a diagram illustrating a frequency-domain audio signal according to an exemplary embodiment.

As illustrated in FIG. 4, the terminal apparatus 100 may acquire different frequency-domain audio signals in units of frames by frequency-converting an input audio signal. The frequency-domain audio signals may have different amplitude values depending on frequency bands, and the amplitude depending on the frequency band may be represented in a z-axis direction in FIG. 4.

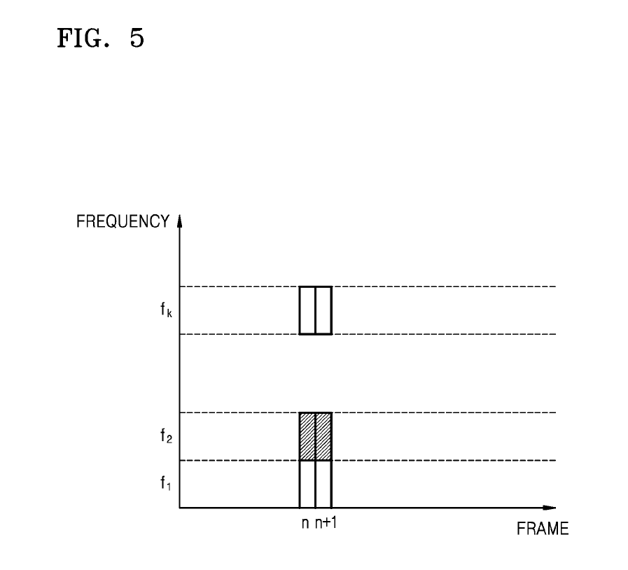

FIG. 5 is a diagram illustrating an example of acquiring a similarity between frequency-domain audio signals belonging to an adjacent frame according to an exemplary embodiment.

Referring to FIG. 5, the terminal apparatus 100 may divide a frequency region into k sections, obtain the similarity between frames in each frequency section, and acquire a representative value such as a mean value or a median value of the similarity values as a similarity value of the audio signal belonging to a frame n and a frame (n+1).

Also, the terminal apparatus 100 may acquire the similarity value of the audio signal, except the similarity value lower than other similarity values, among the similarity values acquired for each frequency section. When a noise is included in the audio signal of a particular frequency region, the similarity value of a noise-containing frequency region may be lower than the similarity values of other frequency regions. Thus, the terminal apparatus 100 may determine that a noise is contained in the section that has a lower similarity value than other frequency regions. The terminal apparatus 100 may acquire the similarity value of the audio signal robustly against a noise by acquiring the similarity value of the audio signal based on the similarity in the remaining sections other than the noise-containing section. For example, in a frequency region f2, when the similarity value of the audio signal belonging to the frame n and the frame (n+1) is lower than the similarity value of the remaining frequency region, the terminal apparatus 100 may obtain the similarity value of the audio signal belonging to the frame n and the frame (n+1) except the similarity value of the frequency region f2.

The terminal apparatus 100 may obtain the similarity between frames based on the similarity value of the audio signal in the remaining section except the section determined as containing a noise.

If determining that the similarity has a relatively low value continuously in certain frame sections in the section determined as including a relatively low similarity value, when obtaining the similarity value of the audio signal in the next frame, the terminal apparatus 100 may obtain the similarity between frames without excluding even the relevant frame having a relatively low similarity value. When a relatively low similarity value is acquired continuously in a certain frequency region, the terminal apparatus 100 may determine that a noise is not included in the audio signal of the relevant frequency region. Thus, the terminal apparatus 100 may obtain the similarity value in the next frame without excluding the similarity value of the relevant section.

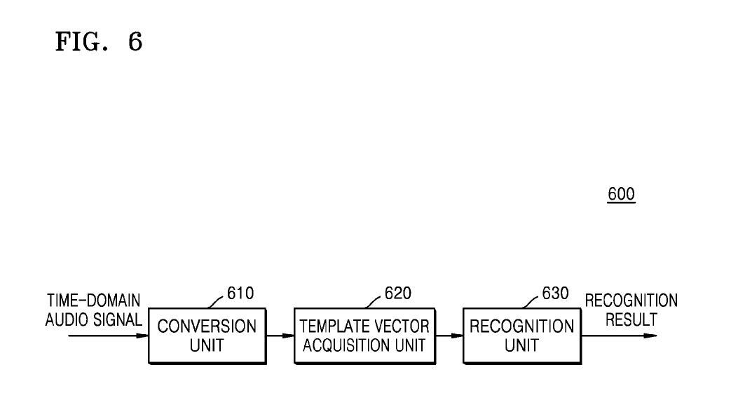

Hereinafter, an apparatus and method for recognizing an audio signal will be described in detail with reference to FIGS. 6 to 9.

FIG. 6 is a block diagram illustrating an internal structure of a terminal apparatus for recognizing an audio signal according to an exemplary embodiment.

A terminal apparatus 600 for recognizing an audio signal may recognize an audio signal by using learning data and output the recognition result thereof. The learning data may include information about a template vector and a sequence of template vectors acquired by the terminal apparatus 100 for learning an audio signal. Based on the learning data that is information about sounds pre-registered by the user, the terminal apparatus 600 may determine whether an input audio signal is one of the sounds pre-registered by the user.

The terminal apparatus 600 for recognizing an audio signal according to an exemplary embodiment may be any terminal apparatus that may be used by the user. For example, the terminal apparatus 600 may include smart televisions (TVs), ultra high definition (UHD) TVs, monitors, personal computers (PCs), notebook computers, mobile phones, tablet PCs, navigation terminals, smart phones, personal digital assistants (PDAs), portable multimedia players (PMPs), and digital broadcast receivers. The terminal apparatus 600 is not limited to the above example and may include various types of apparatuses. The terminal apparatus 600 may be included in the same apparatus together with the terminal apparatus 100 for learning an audio signal.

A conversion unit 610 may convert a time-domain audio signal input to the terminal apparatus 600 into a frequency-domain audio signal. The conversion unit 610 may frequency-convert an audio signal in units of frames to acquire at least one frequency-domain audio signal including frames. The conversion unit 610 is not limited thereto and may frequency-convert a time-domain audio signal in various time units.

A template vector acquisition unit 620 may acquire a template vector that is most similar to a vector of each frame. The vector represents a frequency-domain audio signal. The template vector acquisition unit 620 may acquire a template vector, which is most similar to a vector of each frame, by obtaining the similarity between vectors and at least one template vector that is to be compared.

However, when the maximum value of a similarity value is smaller than or equal to a reference value, the template vector acquisition unit 620 may determine that there is no template vector for the relevant vector.

Also, the template vector acquisition unit 620 may acquire a sequence of template vectors in units of frames based on identification information of the acquired template vectors.

Based on the sequence of template vectors acquired by the template vector acquisition unit 620, a recognition unit 630 may determine whether the input audio signal includes the pre-registered sound. The recognition unit 630 may acquire the similarity between the sequence of template vectors acquired by the template vector acquisition unit 620 and the sequence of template vectors included in the pre-stored learning data. Based on the similarity, the recognition unit 630 may recognize the audio signal by determining whether the input audio signal includes the pre-registered sound. When the similarity value is greater than or equal to a reference value, the recognition unit 630 may recognize that the input audio signal includes the sound of the relevant learning data.

The terminal apparatus 600 according to an exemplary embodiment may recognize the audio signal in consideration of not only the template vectors but also the sequence of template vectors. Thus, the terminal apparatus 600 may recognize the audio signal by using a relatively small amount of learning data.

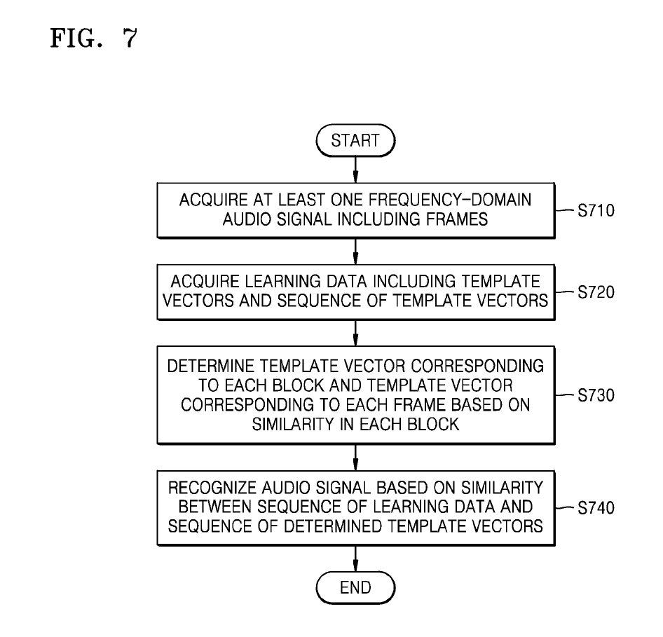

FIG. 7 is a flowchart illustrating a method for recognizing an audio signal according to an exemplary embodiment.

Referring to FIG. 7, in operation S710, the terminal apparatus 600 for recognizing an audio signal may acquire at least one frequency-domain audio signal including frames. The terminal apparatus 600 may convert a time-domain audio signal into a frequency-domain audio signal. The above audio signal may include a sound that is recorded through a microphone. The terminal apparatus 600 may use the pre-stored learning data to determine whether the audio signal includes the pre-registered sound.

In operation S720, the terminal apparatus 600 may acquire the learning data including the template vectors and the sequence of template vectors. The learning data including the template vectors and the sequence of template vectors may be stored in a memory of the terminal apparatus 600.

In operation S730, the terminal apparatus 600 may acquire a template vector corresponding to each frame based on the similarity between the template vector and the frequency-domain audio signal. The terminal apparatus 600 may determine a template vector, which is most similar to each vector, by obtaining the similarity between the vector of each frame and at least one template vector acquired. However, when the similarity value is smaller than or equal to a reference value, the terminal apparatus 600 may determine that there is no template vector similar to the relevant vector.

In operation S740, based on the similarity between the sequence of template vectors acquired in operation S720 and the sequence of template vectors acquired in operation S730, the terminal apparatus 600 may recognize the audio signal by determining whether the input audio signal includes the pre-learned audio signal. The terminal apparatus 600 may determine the sequence of the template vector having the highest similarity among the sequence of at least one template vector. When the maximum similarity value is greater than or equal to a reference value, the terminal apparatus 600 may determine that the input audio signal includes the audio signal of the sequence of the relevant template vector. However, when the maximum similarity value is smaller than or equal to a reference value, the terminal apparatus 600 may determine that the input audio signal does not include the pre-learned audio signal.

For example, an edit distance algorithm may be used to obtain the similarity between the sequences of the template vectors. The edit distance algorithm is an algorithm for determining how similar two sequences are, wherein the similarity may be determined as being higher as the value of the last blank decreases.

When the sequence of template vectors stored as the learning data is [T1, T1, −1, −1, T2, T2] and the sequence of template vectors of the audio signal to be recognized is [T1, T1, T1, −1, −1, T2], the final distance may be obtained through the edit distance algorithm as shown in Table 1 below. When there is no template vector similar to the vector of the relevant frame, it may be represented as “−1” in the sequence of template vectors.

According to the edit distance algorithm, bold characters in Table 1 may be determined by the following rule. When the compared characters are identical, the value above the diagonal left may be written in as it is; and the compared characters are different, the value obtained by adding 1 to the smallest value among the values above the diagonal left, on the left side, and on the upper side may be written in. When each blank is filled in the above manner, the final distance in Table 1 is 2 located in the last blank.

TABLE 1

| | | T1 | T1 | −1 | −1 | T2 | T2 |
|---|---|---|---|---|---|---|---|
| | 0 | 1 | 2 | 3 | 4 | 5 | 6 |
| T1 | 1 | 0 | 1 | 2 | 3 | 4 | 5 |
| T1 | 2 | 1 | 0 | 1 | 2 | 3 | 4 |
| T1 | 3 | 2 | 1 | 1 | 2 | 3 | 4 |
| −1 | 4 | 3 | 2 | 1 | 1 | 2 | 3 |
| −1 | 5 | 4 | 3 | 2 | 1 | 2 | 3 |
| T2 | 6 | 5 | 4 | 3 | 2 | 1 | 2 |

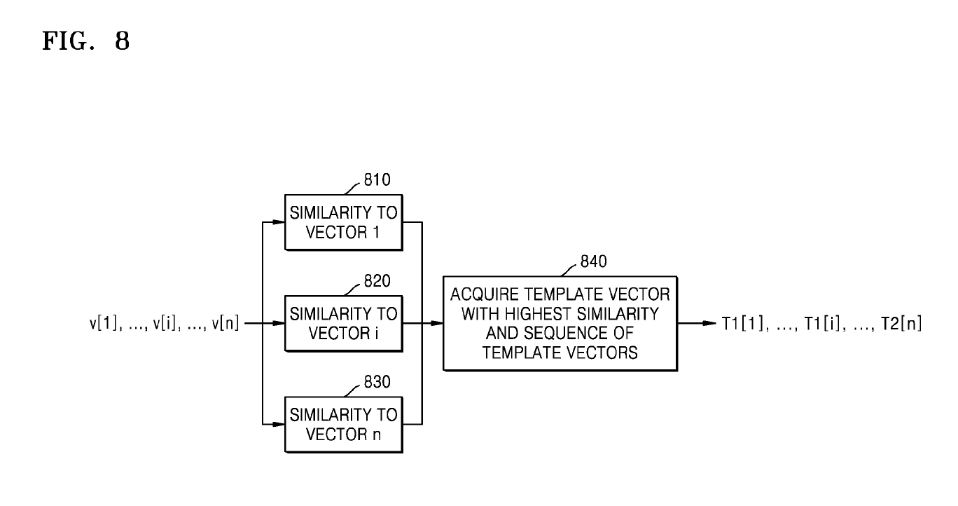

FIG. 8 is a block diagram illustrating an example of acquiring a template vector and a sequence of template vectors according to an exemplary embodiment.

Referring to FIG. 8, the terminal apparatus 600 may obtain the similarity to the template vector with respect to frequency-domain signals v[1], , v[i], , v[n] for each frame of the audio signal. When the frequency-domain signal for each frame is referred to as a vector, the similarities of at least one template vector to a vector 1, a vector i, and a vector n may be acquired in 810 to 830.

Also, in 840, the terminal apparatus 600 may acquire the template vector with the highest similarity to each vector and the sequence of template vectors. When the template vectors with the highest similarities to the vector 1, the vector i, and the vector n are respectively T1, T1, and T2, the sequence of template vectors may be acquired as T1[1], , T1[i], , T2[n] as illustrated.

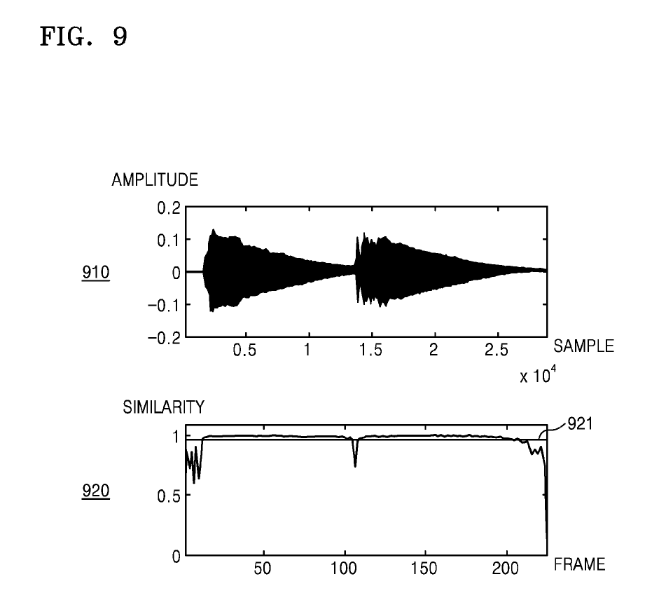

FIG. 9 is a diagram illustrating an example of acquiring a template vector according to an exemplary embodiment.

“910” is a graph illustrating an example of a time-domain audio signal that may be input to the terminal apparatus 600. The terminal apparatus 600 may divide the audio signal illustrated in the graph 910 into frames and acquire a frequency-domain audio signal for each frame. “920” is a graph illustrating the similarity between at least one template vector and a frequency-domain audio signal that is obtained by frequency-converting an audio signal. The maximum value of the similarity value between the template vector and the frequency-domain audio signal of each frame may be illustrated in the graph 920.

When the similarity value is smaller than or equal to a reference value 921, it may be determined that there is no template vector for the relevant frame. Thus, in the graph 920, the template vector for each frame may be determined in the section where the similarity value is greater than or equal to the reference value 921.

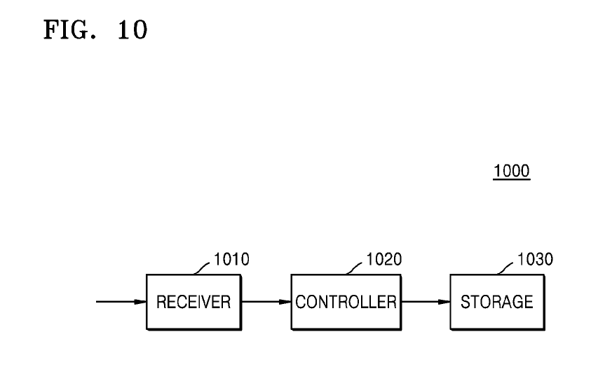

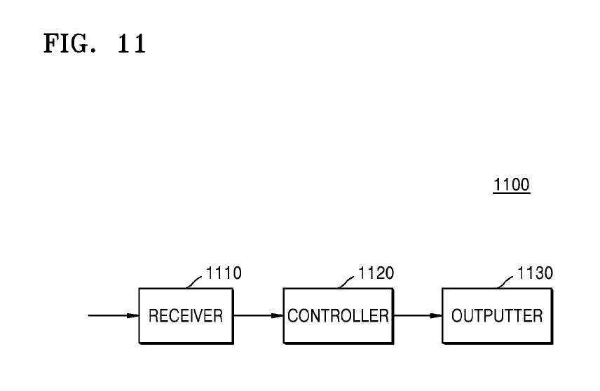

Hereinafter, the internal structure of the terminal apparatus 100 for learning an audio signal and the internal structure of the terminal apparatus 600 for recognizing an audio signal will be described in more detail with reference to FIGS. 10 and 11.

FIG. 10 is a block diagram illustrating an internal structure of a terminal apparatus 1000 for learning an audio signal according to an exemplary embodiment. The terminal apparatus 1000 may correspond to the terminal apparatus 100 for learning an audio signal.

Referring to FIG. 10, the terminal apparatus 1000 may include a receiver 1010, a controller 1020, and a storage 1030.

The receiver 1010 may acquire a time-domain audio signal that is to be learned. For example, the receiver 1010 may receive an audio signal through a microphone according to a user input.

The controller 1020 may convert the time-domain audio signal acquired by the receiver 1010 into a frequency-domain audio signal and divide the audio signal into one or more blocks based on the similarity between frames. Also, the controller 1020 may obtain a template vector for each block and acquire a sequence of template vectors corresponding to each frame.

The storage 1030 may store the sequence of template vectors and the template vectors of the audio signal acquired by the controller 1020 as the learning data for the audio signal. The stored learning data may be used to recognize the audio signal.

FIG. 11 is a block diagram illustrating an internal structure of a terminal apparatus for recognizing an audio signal according to an exemplary embodiment. The terminal apparatus 1100 may correspond to the terminal apparatus 600 for recognizing an audio signal.

Referring to FIG. 11, the terminal apparatus 1100 may include a receiver 1110, a controller 1120, and an outputter 1130.

The receiver 1110 may acquire an audio signal that is to be recognized. For example, the receiver 1110 may acquire an audio signal input through a microphone.

The controller 1120 may convert the audio signal input by the receiver 1110 into a frequency-domain audio signal and acquire the similarity between the frequency-domain audio signal and the template vector of the learning data in units of frames. The template vector with the maximum similarity may be determined as the template vector corresponding to the vector of the relevant frame. Also, the controller 1120 may acquire the sequence of template vectors determined based on the similarity and acquire the similarity to the sequence of template vectors stored in the learning data. When the similarity between the sequences of template vectors is greater than or equal to a reference value, the controller 1120 may determine that the audio signal input by the receiver 1110 includes the audio signal of the relevant learning data.

The outputter 1130 may output the recognition result of the audio signal input by the controller 1120. For example, the outputter 1130 may output the identification information of the recognized audio signal to (through) a display screen or a speaker. When the input audio signal is recognized as a doorbell sound, the outputter 1130 may output a notification sound or a display screen for notifying that the doorbell sound is recognized.

According to an exemplary embodiment, since the number of times of inputting the audio signal including the same sound may be minimized, the sound learning process may be performed more simply.

The methods according to the exemplary embodiments may be stored in computer-readable recording mediums by being implemented in the form of program commands that may be performed by various computer means. The computer-readable recording mediums may include program commands, data files, and data structures either alone or in combination. The program commands may be those that are especially designed and configured for the inventive concept, or may be those that are publicly known and available to those of ordinary skill in the art. Examples of the computer-readable recording mediums may include magnetic recording mediums such as hard disks, floppy disks, and magnetic tapes, optical recording mediums such as compact disk-read only memories (CD-ROMs) and digital versatile disks (DVDs), magneto-optical recording mediums such as floptical disks, and hardware devices such as read-only memories (ROMs), random-access memories (RAMs), and flash memories that are especially configured to store and execute program commands. Examples of the program commands may include machine language codes created by a compiler, and high-level language codes that may be executed by a computer by using an interpreter.

While the inventive concept has been particularly shown and described with reference to exemplary embodiments thereof, those of ordinary skill in the art will understand that various deletions, substitutions, or changes in form and details may be made therein without departing from the scope of the inventive concept as defined by the following claims. Thus, the scope of the inventive concept will be defined not by the above detailed descriptions but by the appended claims. All modifications within the equivalent scope of the claims will be construed as being included in the scope of the inventive concept.

1. A method for learning an audio signal, the method comprising:
acquiring at least one frequency-domain audio signal including frames;
dividing the frequency-domain audio signal into at least one block by using a similarity between frames;
acquiring a template vector corresponding to each block;
acquiring a sequence of the acquired template vectors corresponding to at least one frame included in each block; and
generating learning data including the acquired template vectors and the sequence of the template vectors.

2. The method of claim 1, wherein the dividing of the frequency-domain audio signal into at least one block comprises dividing at least one frame with the similarity greater than or equal to a reference value into at least one block.

3. The method of claim 1, wherein the acquiring of the template vector comprises:
acquiring at least one frame included in the block; and
obtaining a representative value of the acquired frame; and
determining the template vector as the obtained representative value.

4. The method of claim 1, wherein the acquiring of the sequence of the acquired template vectors comprises:
allocating identification information to the template vectors; and
obtaining the sequence of the template vectors by using the identification information of the template vectors.

5. The method of claim 1, wherein the dividing of the frequency-domain audio signal into at least one block comprises:
dividing a frequency band into sections;
obtaining a similarity between frames in each section;
determining a noise-containing section among the sections based on the similarity in each section; and
obtaining the similarity between the frames based on the similarity in the other section other than the determined noise-containing section.

6. A method for recognizing an audio signal, the method comprising:
acquiring at least one frequency-domain audio signal including frames;
acquiring learning data including template vectors and a sequence of the template vectors;
determining a template vector corresponding to each frame based on a similarity between the template vector and the frequency-domain audio signal; and
recognizing the audio signal based on a similarity between a sequence of the learning data and a sequence of the determined template vectors.

7. The method of claim 6, wherein the determining of the template vector corresponding to each frame comprises:
obtaining a similarity between the template vector and the frequency-domain audio signal of each frame; and
determining the template vector as the template vector corresponding to each frame when the similarity is greater than or equal to a reference value.

8. A terminal apparatus for learning an audio signal, the terminal apparatus comprising:
a receiver configured to receive at least one frequency-domain audio signal including frames;
a controller configured to divide the frequency-domain audio signal into at least one block by using a similarity between frames, acquire a template vector corresponding to each block, acquire a sequence of the acquired template vectors corresponding to at least one frame included in each block, and generate learning data including the acquired template vectors and the sequence of the template vectors; and
a storage configured to store the learning data.

9. The terminal apparatus of claim 8, wherein the controller divides at least one frame with the similarity greater than or equal to a reference value into at least one block.

10. The terminal apparatus of claim 8, wherein the controller acquires at least one frame included in the block, obtains a representative value of the acquired frame, and determines the template vector as the obtained representative value.

11. The terminal apparatus of claim 8, wherein the controller divides a frequency band into sections, obtains a similarity between frames in each section, determines a noise-containing section among the sections based on the similarity in each section, and obtains the similarity between the frequency-domain audio signals belonging to the adjacent frame based on the similarity in the other section other than the determined section.

12-13. (canceled)

14. A computer-readable recording medium storing a program for implementing the method of claim 1.

15. The terminal apparatus of claim 8, wherein the controller allocates identification information to the template vectors, and obtains the sequence of the template vectors by using the identification information of the template vectors.

16. The method of claim 5, wherein the determining of the noise-containing section comprises:
determining the noise-containing section in a current frame based on the similarity in each section in a previous frame.

17. The terminal apparatus of claim 11, wherein the controller determines the noise-containing section in a current frame based on the similarity in each section in a previous frame.
